(19) United States
(12) Patent Application Publication
(10) Pub. No.: US 2005/0205609 A1
(43) Pub. Date: Sep. 22, 2005

(54) Aerating Decanter with Dispensing Valve.

(75) Inventor: James R. Moore, Nashville, TN (US)

Correspondence Address: James Moore, 813 Russleo Drive, Nashville, TN, 37209, US

(73) Assignee: James R. Moore, Nashville, TN (US)

(21) Appl. No.: 10/708,625

(22) Filed: Mar. 16, 2004

(51) Int. Cl. B67D 5/62

(52) U.S. Cl. 222/185.1; 222/146.6

(57) ABSTRACT

This invention combines several processes into on easy to use product. The glass sphere dramatically enhances the aeration procedure by gently exposing air to thin waves of wine as wine passes over the surface of the sphere. The integrated filter provides a larger surface than normally found in wine filtration devices. The supporting structure secures the decanter in such a way that consumers can easily dispense wine without handling a wine bottle or conventional decanter.

### CROSS REFERENCE TO RELATED APPLICATIONS

### BACKGROUND OF INVENTION

At present there are a variety of methods a consumer can use to aerate wines. These processes range from manual to highly mechanized methods. Manually, wine is poured into a vessel, which exposes the wine to the air as it is transferred from the bottle. There are many artistic decanters on the market to accomplish this task ranging from pitchers to highly crafted crystal containers. Some specialty devices have been created to assist in aerating wine introduced into decanters which regulate the flow of wine into the decanter (U.S. Pat. No. 5,293,912). None of these vessels dispense wine from the vessel into their glass without pouring. Mechanically, there are apparatuses that; inject air into the wine bottle, (U.S. Pat. Nos. 4,494,452 4,785,724 5,595,104 6,508,163); transfer wine back and forth between decanters (U.S. Pat. No. 4,162,129); as well as swirling the wine with a magnetic motor driven oscillator (U.S. Pat. No. 6,332,706).

Although each of the aforementioned methods serve the purpose of aerating wine, at present there are not any such devices that provide the aeration process coupled with a filtering device where a consumer can serve themself without pouring from a container.

Beyond the added functionality of a self serving wine dispenser which filters and aerates wine, the invention also presents a certain aesthetic quality that enables the consumer to display and use the invention in nearly every social setting where wine is served. This is all done in absence of mechanical motors and drives, providing an ambiance missing from the mechanical apparatus.

### SUMMARY OF INVENTION

The invention provides the consumer a means to aerate wine, trap particulates that may have formed in the bottle during fermentation or those introduced during the process of uncorking the a bottle of wine, and dispense wine into a suitable receptacle.

To use the invention, a valve is secured to the base of the decanter. The base of the decanter has an internal flange to which the valve is attached.

Once the valve is secured to the opening, the glass decanter is positioned on the structural support and secured in place. A fine stainless steel mesh filter is positioned at the mouth of the decanter and allowed to rest on the indention ring that secures the decanter to the structure. Once the filter is in place, the glass sphere is placed on the concave shape of the filter. Water inside the sphere provides the necessary weight to keep the sphere stationary while pouring wine over its surface.

With all components in place, wine is poured over the surface of the glass sphere. Capillary action between the glass surface and the wine draws the wine over the surface of the sphere releasing the wine where the filter comes into contact with the sphere. Wine then collects in the decanter for dispensing through the spring loaded valve.

Some wines require decanting prior to serving due to a large amount of sediment that has formed over time. Through decanting, sediment settles to the bottom of the bottle. Some of the sediment may be accidentally poured from the bottle as the bottle is emptied. The decanter is designed to allow those particles to be trapped in the section above the indention ring of the decanter, delineated by the filter. The decanter's wine capacity is such that a full bottle of wine fills the decanter above the indention ring and any sediment will be released into this section. Once wine is dispensed, the wine level recedes slowly as the consumer fills their glass, trapping particles on the upper glass surfaces as well as the filter.

In the event white wines are preferred, the glass sphere may be frozen to assist in the preservation of cooler wine temperatures. A previous patent was secured for this function in 1903 by August Glebsattel, (U.S. Pat. No. 740,847) although the intent was primarily for health purposes. The cooling is accomplished by 3 avenues. First, as wine passes over the surface of the sphere, the wine is cooled without diluting its contents with water. Second, once a full bottle is poured into the decanter, the level of the wine from a full bottle fully contacts the sphere and chills the wine. Third, once some of the wine is dispensed, the stainless steel filter can be removed and the sphere positioned on the indention ring. This provides a mechanical seal impeding the flow of air to the surface of the wine and provides cool air for the top half of the decanter.

### BRIEF DESCRIPTION OF DRAWINGS

There are 8 figures that show various aspects of the invention. The first 3 figures show the orthogonal views of the assembly.

FIG. 4 is a cross section of the assembly showing the interior mechanisms.

FIG. 5 shows the assembly detail of the decanter as described in paragraphs 0006 and 0007. It also illustrates the path the wine takes as it is poured into the decanter.

FIG. 6 shows the relief created in the filter to allow air to be displaced as wine enters the decanter.

FIG. 7 shows the various components of the nozzle in the closed position, where

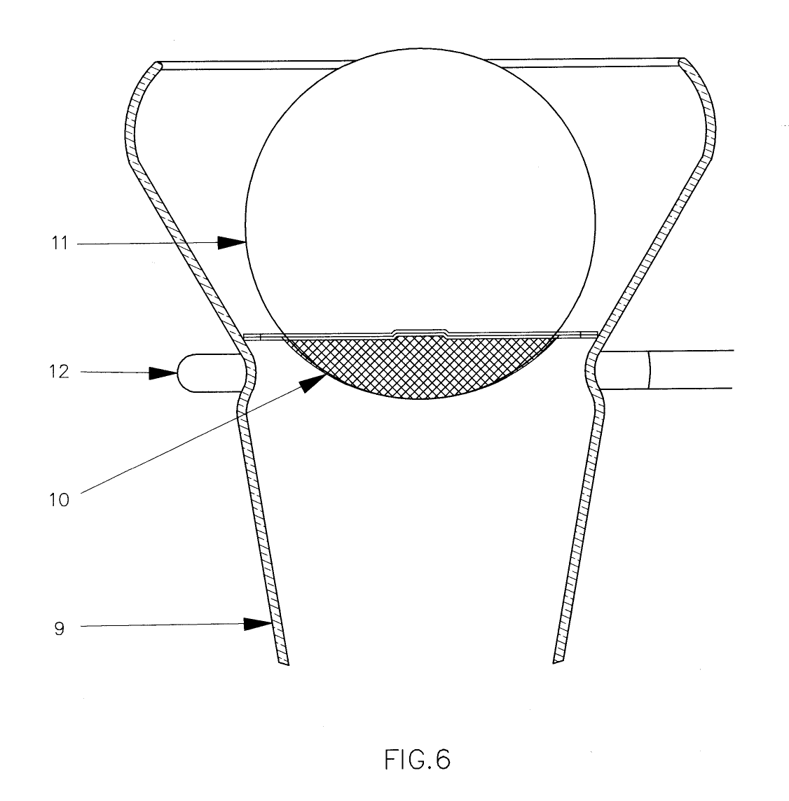

FIG. 8 shows the nozzle in the open position.

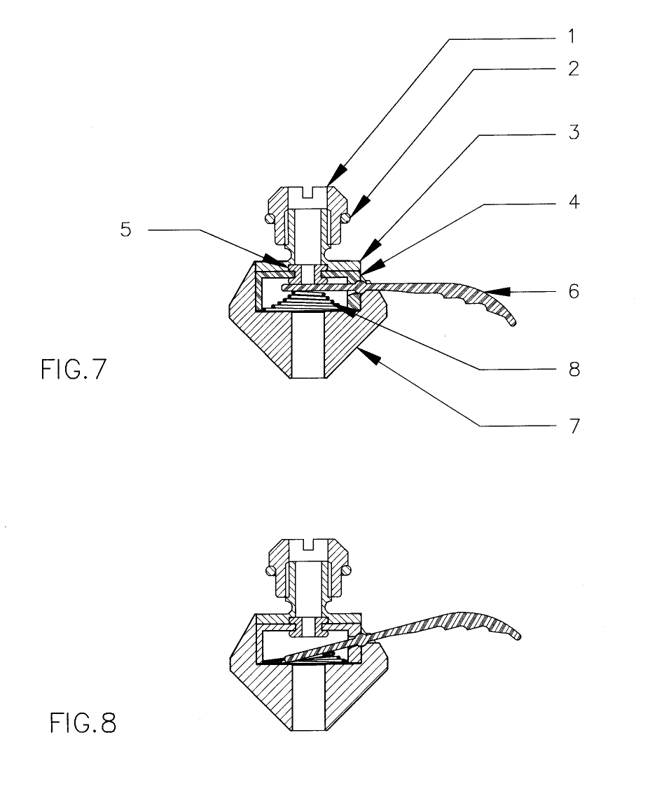

### DETAILED DESCRIPTION

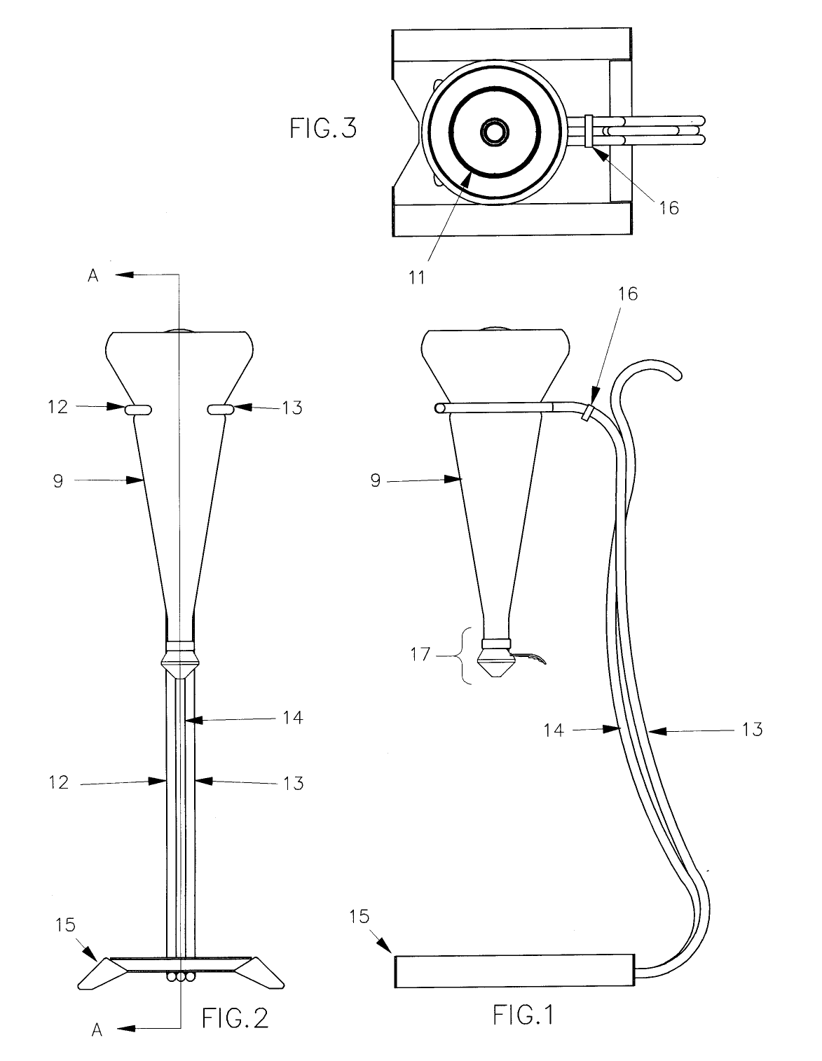

The described invention provides an artistic mechanism to aerate, filter, chill and store wine for easy dispensing into a wine glass. The basic components of the invention are described as a decanter (9) which houses the nozzle (17), filter (10), and wine bubble (11). The decanter (9) is mechanically attached to the right (13) and left (12) hand support rods. These rods as well as the center decorative rod (14) are welded or otherwise attached to the base (15). A clip (16) bridges the right (13) and left (12) hand supports to squeeze the rods against the decanter (9) at the indention ring (18) (FIG. 4). This holds the decanter (9) firmly in the support structure. When the clip (16) is removed the decanter (9) can then be removed from the support structure for cleaning.

The valve (17) which dispenses wine is a spring (8) loaded devise which is activated by physically rotating the lever (6) upward in order to pivot the lever (6) away from the grommet (5). The valve chamber (4) maintains the relationship between the grommet (5) and lever (6). These items are held in place by the valve body (7) housing and pressed in place by the valve post (3). These items comprise the valve (17).

The valve (17) is mechanically attached to the decanter (9) with the valve nut (1). An O-ring (2) is positioned on the nut (1) prior to attaching it to the decanter (9) to prevent leaks. The O-ring (2) seals against an internal flange molded into the nose of the decanter (9). Since the nut (1) and post (3) are threaded, the valve (17) can be removed for maintenance.

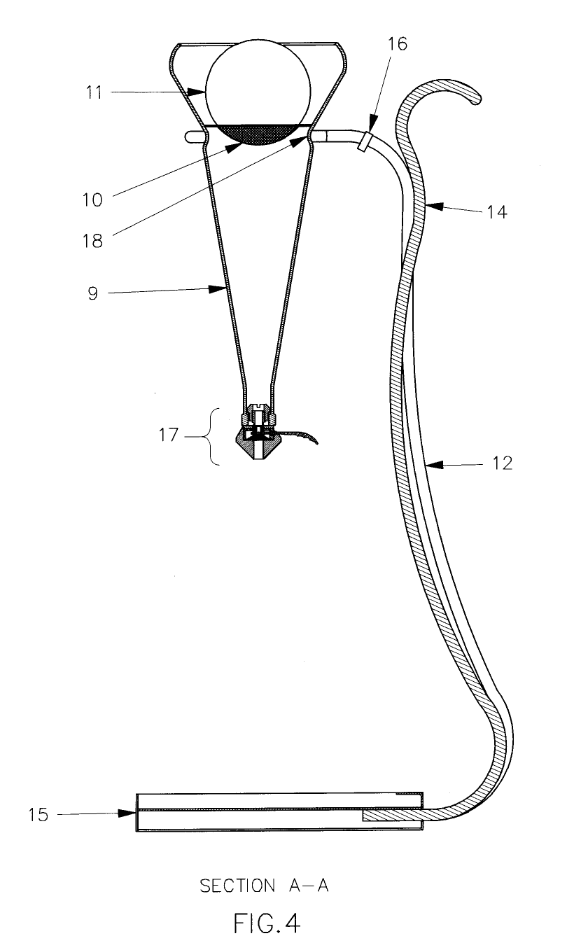

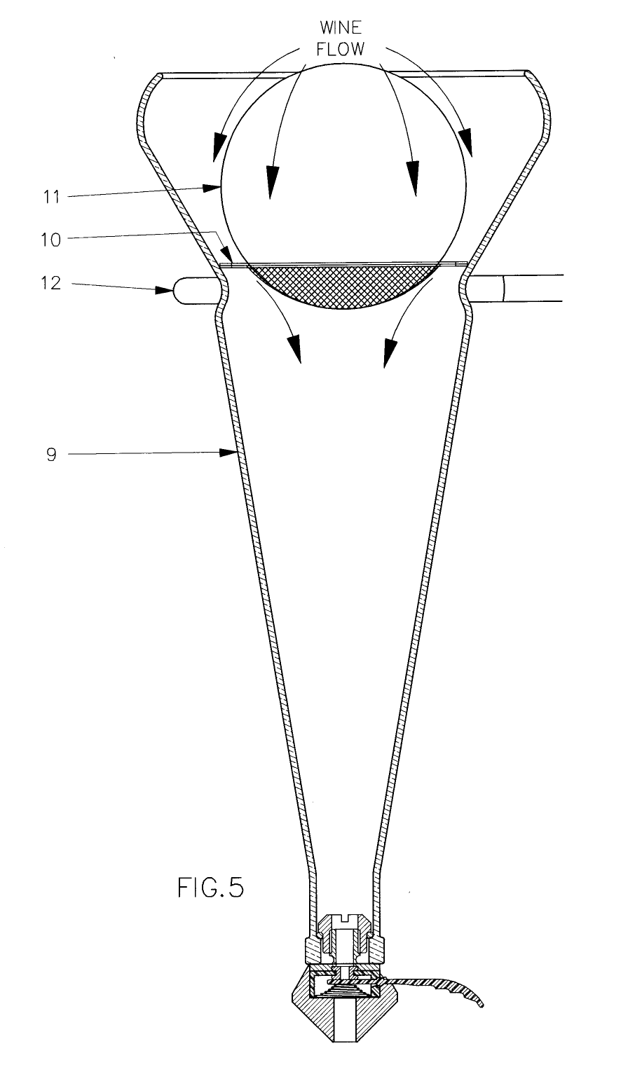

FIG. 5 illustrates the flow of wine through the decanter (9). As wine is introduced to the decanter (9), it first makes contact with the wine bubble (11). The arrows show the directional flow of wine over the surface. As the wine travels down, it coats the wine bubble (11) which creates a thin film where air can readily mix with virtually every drop of wine. As the wine makes contact with the filter (10), a slight amount of turbulence is created which gently agitates the wine. At this juncture, sediment and unwanted items are removed from the pour. At times, the wine will coat the entire surface of the filter (10) creating a wine membrane over the surface. For this reason, air vents (FIG. 6) are added to either side of the filter (10) to allow air to escape the decanter (9) as the air is displaced with wine.

1. An open top glass vessel for aerating, filtering and dispensing wine comprising: a gravity fed container to collect and store wine, a glass sphere (containing a liquid medium) to introduce air to the wine as wine passes over the glass surface, a stainless steel mesh to trap sediment and other debris normally introduced during the process of pouring wine from a bottle, and a valve to activate the flow of wine from the vessel to a drinking glass.

2. A structure to support apparatus described in claim 1. This structure may be artistic in nature and made of any suitable material to support said apparatus.

3. The removal of the filtering mechanism in claim 1 and repositioning the glass sphere enables the sphere to seal the opening of the vessel and protect the contents from foreign debris.

4. The glass sphere in claim 1 may be frozen and repositioned at the opening of the vessel to assist in cooling wine as wine passes over the its surface.

5. The valve in claim 1 is spring loaded and as such prevents the flow of wine through the valve opening. The lever that protrudes from the valve allows the flow of wine once the lever is pushed upwards by either the rim of a glass or by another manual means.
